(19) United States
(12) Patent Application Publication
(10) Pub. No.: US 2010/0023347 A1
(43) Pub. Date: Jan. 28, 2010

(54) Medical Marketing With Co-payment Elimination

(76) Inventor: Sheri Sabrdaran, Newport Coast, CA (US)

Correspondence Address: Ashok Tankha, 36 Greenleigh Drive, Sewell, NJ, 08080, US

(21) Appl. No.: 12/177,173

(22) Filed: Jul. 22, 2008

(51) Int. Cl. G06Q 30/00; G06Q 10/00; G06Q 50/00; G06F 17/30; G06Q 20/00

(52) U.S. Cl. 705/3

(57) ABSTRACT

Disclosed herein is a method and system for managing medical payments in a medical marketing environment hosted by a service provider. Information of a patient is acquired and healthcare providers are identified based on the acquired patient information and information of identified healthcare providers is provided to the patient. The patient selects one or more of the identified healthcare providers for a medical service and prioritizes them. The patient information is transferred to a selected healthcare provider for acceptance to provide the medical service to the patient. The selected healthcare provider that accepts to provide the medical service to the patient, signs an agreement for not accepting co-payment from the patient. An appointment is scheduled between the patient and the selected healthcare provider. The service provider pays a co-payment to the selected healthcare provider on behalf of the patient in exchange for a minimal referral fee.

### BACKGROUND

This invention, in general, relates to marketing. More particularly, this invention relates to managing medical payments and saving healthcare costs for the patient and the marketing cost for the healthcare providers through minimal effort and marketing.

When patients require healthcare, the patients are free to select the healthcare provider for treatment without knowing the competency level of the healthcare provider and may, in some instances, end up consulting an incorrect or inappropriate healthcare provider. Some patients may not be aware of healthcare providers and healthcare centers in their vicinity and may travel farther distances in search of the same. The patient may also find it difficult to obtain an appointment with the healthcare provider if the particular healthcare provider is busy.

In the current healthcare provider market, the medical expenses for patients with or without insurance are very high. When an insured patient obtains healthcare or medical services from a healthcare provider, the patient typically pays a co-payment to the healthcare provider when the medical services are covered by their insurance plan. In most cases, the amount of the co-payment for many of the medical services is unknown to the patient. The patient does not know the amount billed for a medical service and the amount to be paid by the insurance company. Therefore, the patient has to wait for an explanation of the benefit (EOB) to obtain the exact co-payment amount. After payment of the co-payment amount, the remaining medical bill is to be paid by the insurance company. The co-payment is generally more expensive if the patient has to undergo major medical treatment. The co-payment amount may vary depending on the service, generally with low co-payments required for visits to a regular healthcare provider and higher co-payments for services received in the emergency room, diagnostic centers and hospitalizations. In some instances patients may be discouraged from taking proper care of their health due to the uncertainty or absence of knowledge of the co-payment amount. The patient may also avoid going for routine checkups unless an emergency or serious illness occurs. Also insurance companies may raise deductible amounts which some patients cannot afford. Moreover, an uninsured patient has to pay the entire medical bill and is not entitled to any benefits.

Hence, there is a need for a method and system that manages medical payments for insured patients and uninsured patients in a medical marketing environment. There is also a need for marketing services of healthcare providers in the medical marketing environment to create awareness among the patients and generate more patients for the healthcare providers. There is also a need for eliminating or reducing the co-payment and the deductible paid by the patients to the healthcare providers, thereby enabling affordable healthcare for the patients. There is also a need for saving the healthcare cost for the patients and the marketing cost for the healthcare providers through minimal effort and marketing. There is also a need for the healthcare providers to obtain more patients and a need for patients to know the exact liability for their medical bill.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein addresses the above stated needs for managing medical payments for insured patients and uninsured patients in a medical marketing environment hosted by a service provider. The medical marketing may be performed via an online medical marketing website, a customer service department, a direct marketing environment, etc. The method and system disclosed herein further provides marketing of healthcare providers in the medical marketing environment, generates more patients for the healthcare providers, and saves the marketing cost for the healthcare providers. The method and system disclosed herein further eliminates or reduces the co-payment and the deductible paid by the patients to the healthcare providers, thereby enabling affordable healthcare for the patients.

The service provider hosts the medical marketing environment. A patient may register with an insured section or an uninsured section in the medical marketing environment and pay a minimal referral fee. The patient pays the minimal referral fee each time the patient is referred to a healthcare provider for a medical service. The medical service may be a consultation, diagnostics, hospitalization, emergency, physical therapy, surgery, etc. The healthcare providers are registered in the medical marketing environment under a contract and pay predefined subscription fees. Information of the patient, belonging to the insured section or the uninsured section, is acquired from the patient. The patient information may comprise one or more of personal information, insurance cover information, and health condition information.

Healthcare providers are identified based on the acquired patient information and information of the healthcare providers is provided to the patient. If the patient registers with the uninsured section, the information of the healthcare providers providing discounted medical fees is provided to the patient. The healthcare providers may be categorized based on one or more of medical specialization, location, and patient insurance. The patient selects one or more of the identified healthcare providers for the medical service and prioritizes the selected healthcare providers. The acquired patient information is transferred to a selected healthcare provider based on the prioritization by the patient for acceptance by the selected healthcare provider to provide the medical service to the patient. The selected healthcare provider has an option of accepting or rejecting to provide the medical service to the patient.

On acceptance by the selected healthcare provider to provide the medical service to the patient, the selected healthcare provider signs an agreement for not accepting co-payment from the patient. If the selected healthcare provider rejects to provide the medical service, the acquired patient information is transferred to the next selected healthcare provider prioritized by the patient. The selected healthcare provider accepts the co-payment from the service provider instead of the patient on signing the agreement. An agreement may also be signed between the healthcare provider and the patient for the discounted medical fees and other discounts. An appointment is then scheduled between the patient and the selected healthcare provider for the medical service. The service provider accepts the minimal referral fee from the patient and pays a co-payment to the selected healthcare provider on behalf of the patient.

The method and system disclosed herein further enables the healthcare providers to advertise services. The healthcare providers are charged for the advertising. In most cases, advertising charges offset the co-payment which is owed to the healthcare provider by the service provider.

The method and system disclosed herein therefore manages medical payments between the patient and the healthcare providers and waives the co-payment to be paid by the patient to the healthcare provider in exchange for the minimal referral fee, thereby saving healthcare costs for the patient.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of managing medical payments in a medical marketing environment.

FIG. 2 illustrates a system for managing medical payments in a medical marketing environment.

FIG. 3 exemplarily illustrates a flowchart for contacting a healthcare provider for a medical service by a patient on a medical marketing website.

FIG. 4 exemplarily illustrates a flowchart for referring the patient to the healthcare provider on the medical marketing website.

FIG. 5 exemplarily illustrates a flowchart for managing medical payments of insured patients and uninsured patients by a service provider.

FIG. 6 exemplarily illustrates a flowchart of managing payments by the healthcare provider on accepting to provide the medical service to an insured patient or an uninsured patient.

FIG. 7 exemplarily illustrates a flowchart of the services provided by the medical marketing website.

FIG. 8 exemplarily illustrates a flowchart for connecting the insured patient and the uninsured patient to the healthcare provider through the medical marketing website.

### DETAILED DESCRIPTION OF THE INVENTION

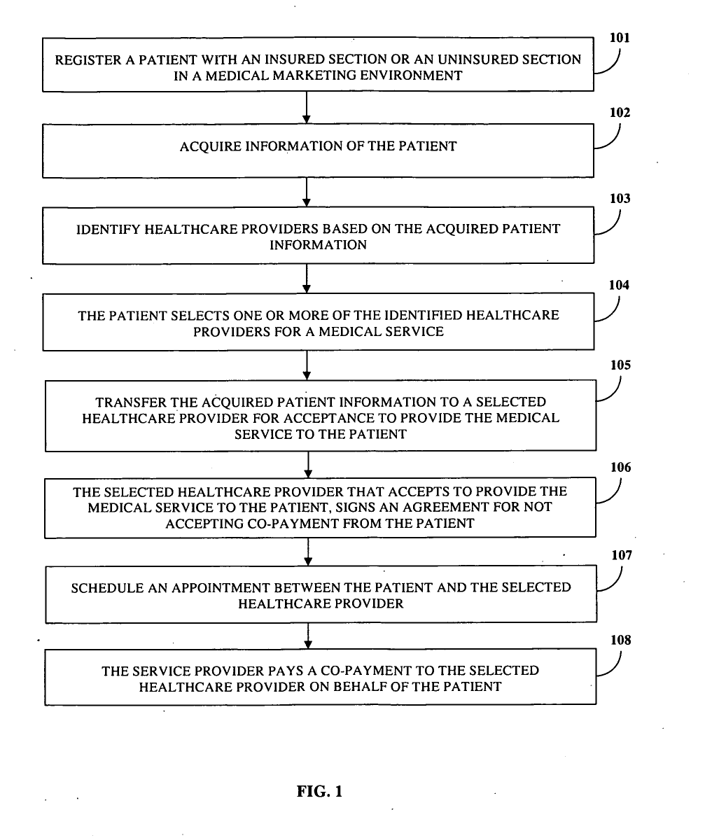

FIG. 1 illustrates a method of managing medical payments in a medical marketing environment. The medical marketing may be performed via a medical marketing website 502, a customer service department, a direct marketing environment, etc. A service provider hosts the medical marketing environment. The service provider may be a host of the medical marketing website 502, customer care personnel, direct marketers of the direct marketing environment, etc. The medical marketing environment comprises an insured section and an uninsured section. A patient 201 may register 101 with the insured section or the uninsured section in the medical marketing environment and pay a minimal referral fee.

Healthcare providers register in the medical marketing environment and pay predefined subscription fees for marketing services in the medical marketing environment. Healthcare providers are those authorized to practice medicine or surgery and those capable of providing healthcare services. For example, the healthcare providers may be one or more of doctors, physicians, dentists, hospitals, diagnostic labs, emergency rooms, chiropractors, clinical psychologists, optometrists, physical therapists, surgeons, clinical social workers, nurse practitioners, nurse midwives, nursing homes, and other medical facilities. The medical marketing environment may enable the healthcare providers to advertise services. The healthcare providers will be charged for the advertising.

Patient information is acquired 102 in the medical marketing environment from the patient 201. The patient information may comprise personal information, insurance cover information, health condition information, etc. The healthcare providers are identified 103 based on the acquired patient information. Information of the identified healthcare providers is provided to the patient 201. The healthcare providers are categorized based on one or more of medical specialization, location, and patient insurance. If the patient 201 registers with the uninsured section, the information of the healthcare providers providing discounted medical fees is provided. The information of the discounted medical fees may also be displayed to the patient 201.

The patient 201 may select 104 one or more of the identified healthcare providers for a medical service. The patient 201 prioritizes the selected healthcare providers. The acquired patient information is transferred 105 to a selected healthcare provider 601 for acceptance to provide the medical service to the patient 201. The acquired patient information is transferred to the selected healthcare provider 601 based on the prioritization by the patient 201. The selected healthcare provider 601 has the option to accept or reject to provide the medical service to the patient 201. If the healthcare provider 601 rejects to provide medical service to the patient 201, the acquired patient information is transferred to the next selected healthcare provider 601 prioritized by the patient 201. If the healthcare provider 601 accepts to provide the medical service to the patient 201, the selected healthcare provider 601 signs 106 an agreement for not accepting co-payment from the patient 201. An agreement may also be signed between the healthcare provider 601 and the patient 201 for the discounted medical fees and other discounts. An appointment is then scheduled 107 between the patient 201 and the selected healthcare provider 601 for the medical service.

The service provider pays 108 a co-payment to the selected healthcare provider 601 on behalf of the patient 201. The selected healthcare provider 601 accepts the co-payment from the service provider instead of the patient 201 on signing the agreement. The co-payment may be an original co-payment, or a portion of the original co-payment due to the healthcare provider 601. The co-payment is a payment made by the patient 201 who has health insurance, usually at the time a service is received, to offset some of the cost of care. The co-payment size may vary depending on the service, generally with low co-payments required for visits to a regular healthcare provider 601 and higher co-payments for services received in the emergency room, diagnostic centers, hospitalizations, etc. The method disclosed herein manages the medical payments between the patient 201 and the healthcare providers and waives the co-payment to be paid by the patient 201 to the healthcare provider 601 in exchange for the minimal referral fee from the patient 201, thereby saving healthcare costs for the patient 201.

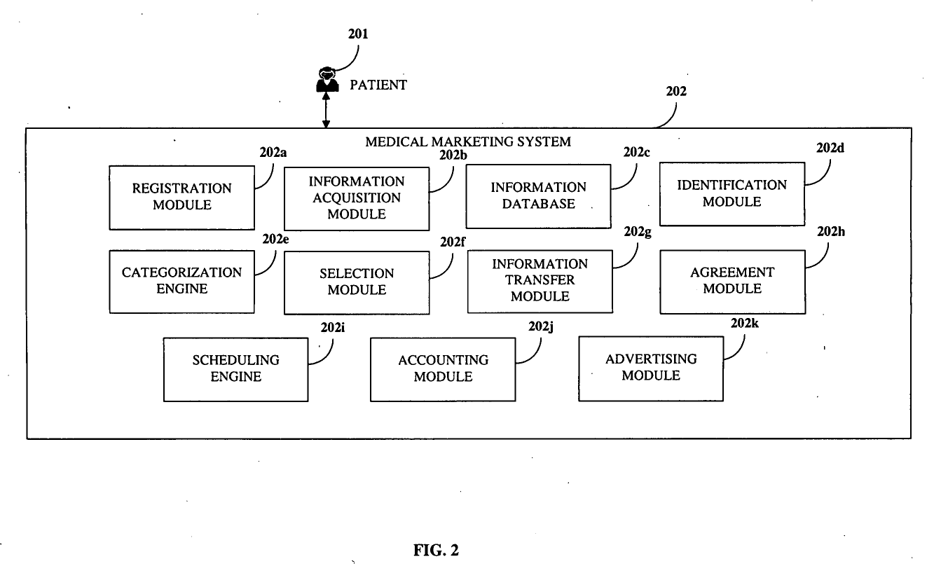

FIG. 2 illustrates a system herein referred to as a “medical marketing system” for managing medical payments in a medical marketing environment. The medical marketing system 202 disclosed herein comprises a registration module 202a, an information acquisition module 202b, an information database 202c, an identification module 202d, a categorization engine 202e, a selection module 202f, an information transfer module 202g, an agreement module 202h, a scheduling engine 202i, an accounting module 202j, and an advertising module 202k. The medical marketing system 202 disclosed herein may be implemented via a medical marketing website 502, a customer service department, a direct marketing environment, etc. A patient 201 may access the medical marketing website 502 using a computing device. The computing device may be a personal computer, a laptop, a mobile phone, a personal digital assistant, an electronic book reader, etc.

The medical marketing system 202 disclosed herein manages medical payments between the patient 201 and healthcare providers. The service provider may refer the patient 201 to a selected healthcare provider 601. The patient 201 may register with an insured section or an uninsured section and pay a minimal referral fee in the medical marketing environment. The patient 201 pays a minimal referral fee each time the patient 201 is referred to a healthcare provider 601 for a medical service. The medical service may be a consultation, diagnostics, hospitalization, emergency, physical therapy, surgery, etc. The registration module 202a registers the patient 201 in the medical marketing environment. The registration module 202a further registers the healthcare providers on receiving the predefined subscription fees.

The information acquisition module 202b acquires information of a patient 201 in the medical marketing environment. The information acquisition module 202b acquires the patient information comprising one or more of personal information, insurance cover information, health condition information, etc. The patient information is stored in the information database 202c. The information database 202c further stores profile information of the healthcare providers.

The identification module 202d identifies healthcare providers based on the acquired patient information. Information of the identified healthcare providers is provided to the patient 201 in the medical marketing environment. The categorization engine 202e categorizes the healthcare providers based on one or more of medical specialization, location, and patient insurance. The selection module 202f enables the patient 201 to select one or more of the identified healthcare providers for a medical service. The selected healthcare providers are prioritized by the patient 201.

The information transfer module 202g transfers the acquired patient information to a selected healthcare provider 601 based on the prioritization by the patient 201 for acceptance to provide the medical service to the patient 201. The selected healthcare provider 601 has an option of accepting or rejecting to provide the medical service to the patient 201. If the selected healthcare provider 601 rejects to provide the medical service to the patient 201, the information transfer module 202g transfers the acquired patient information to the next selected healthcare provider 601 prioritized by the patient 201. If the selected healthcare provider 601 accepts to provide the medical service to the patient 201, the agreement module 202h enables the selected healthcare provider 601 to sign an agreement for not accepting co-payment from the patient 201. The scheduling engine 202i then facilitates scheduling of an appointment between the patient 201 and the selected healthcare provider 601 for the medical service. The accounting module 202j accounts the co-payment to be paid to the selected healthcare provider 601 by the service provider on behalf of the patient 201. The advertising module 202k advertises services of the healthcare providers in the medical marketing environment.

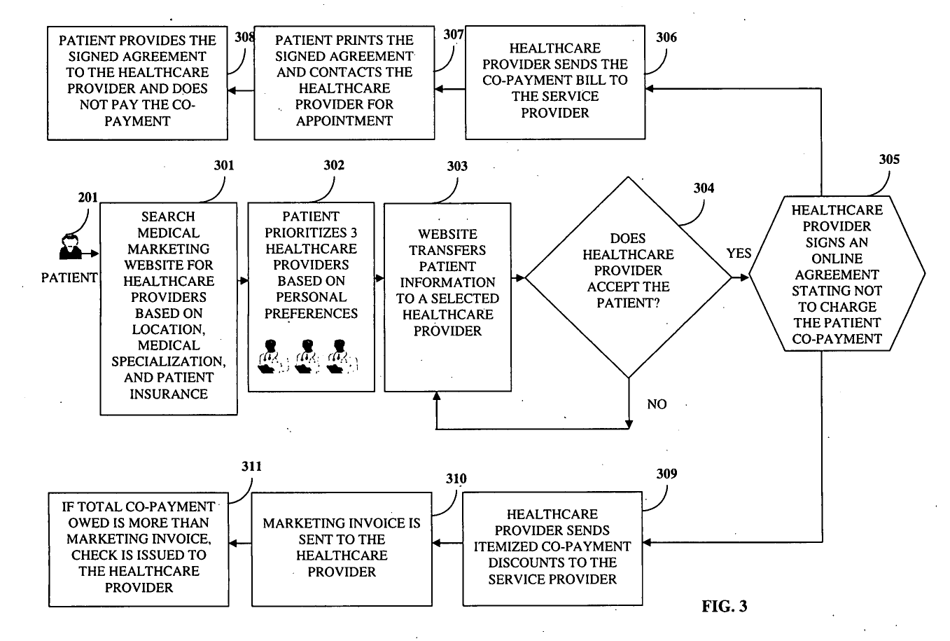

FIG. 3 exemplarily illustrates a flowchart for contacting a healthcare provider 601 for medical service by a patient 201 on a medical marketing website 502. Although FIGS. 3-8 refer to a medical marketing website 502, the medical marketing environment is not limited to a medical marketing website 502, but also includes a customer service department, a direct marketing environment, etc. The patient 201 logs on the medical marketing website 502 that market the services of the healthcare providers. The patient 201 searches 301 for the healthcare providers based on medical specialization, location, and patient insurance. The search is performed by the medical marketing website 502 on acquiring the patient information. The patient 201 prioritizes 302, for example, three healthcare providers based on personal preferences. The medical marketing website 502 transfers 303 the patient information to the selected healthcare provider 601 based on first priority. The medical marketing website 502 ascertains if the selected healthcare provider 601 accepts the patient 201 for medical service. If the selected healthcare provider 601 does not accept 304 the patient 201 for a specified time, for example, 24 hours, the medical marketing website 502 repeats the process and transfers the patient information to the next selected healthcare provider 601 prioritized by the patient 201. If the selected healthcare provider 601 accepts 304 the patient 201, the healthcare provider 601 signs 305 an agreement stating that the healthcare provider 601 will not accept the co-payment from the patient 201 for the referred medical service.

The healthcare provider 601 sends 306 the co-payment bill to the service provider. The patient 201 provides the printed signed agreement to the healthcare provider 601 and does not pay the co-payment. The patient 201 prints 307 the signed agreement and contacts the healthcare provider 601 for the appointment. The patient 201 provides 308 the signed agreement to the healthcare provider 601 and does not pay the co-payment. The healthcare provider 601 may send 309 itemized co-payment discounts to the service provider since the medical marketing website 502 performs marketing for the healthcare provider 601. The service provider further sends 310 a marketing invoice to the healthcare provider 601.

If the total co-payment calculated for a month is more than the marketing invoice, a check is issued 311 to the healthcare provider 601. For example, when the service provider and the healthcare provider 601 enter a marketing agreement, the healthcare provider 601 may not collect the co-payment from the referred patient 201. Every month the healthcare provider 601 may bill the service provider for the co-payments not collected from the patients. The service provider may also invoice the healthcare provider 601 for marketing and advertising efforts which resulted in patient referrals to the healthcare provider 601. The marketing invoice is a larger amount than the total of the discounted co-payments. The marketing invoice may offset the co-payment owed to the healthcare provider 601. If the marketing invoice is less than the co-payment, the service provider will make the check payable to the healthcare provider 601. If the marketing invoice is equal to the co-payment then the service provider sends the adjusted invoice and credits the co-payment total in the marketing invoice. The approved marketing and advertising is permitted for a fee, i.e., the predefined subscription fee. The medical marketing website 502 may also cooperate, for example, with Google® advertising.

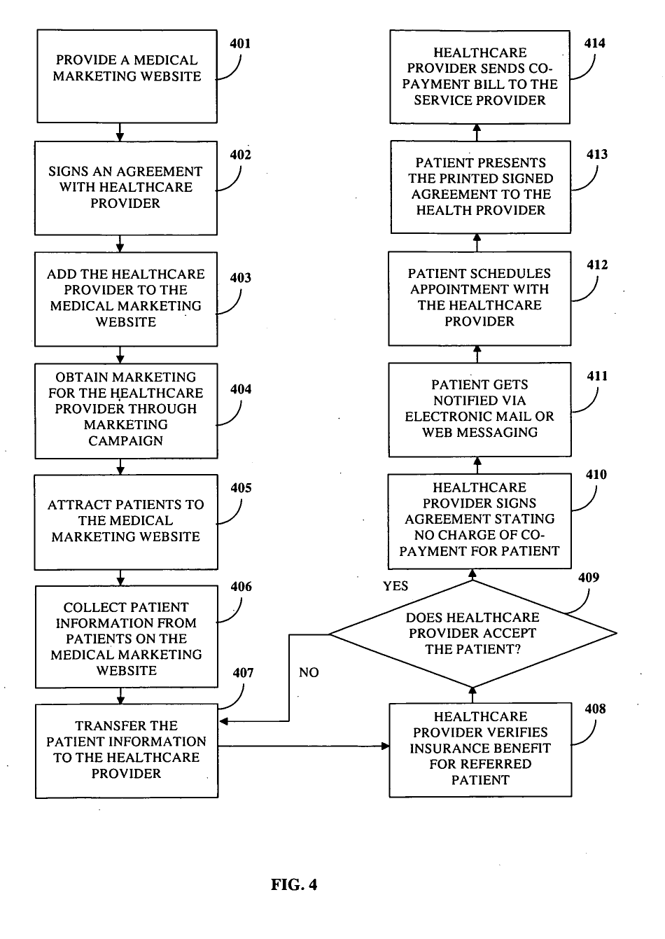

FIG. 4 exemplarily illustrates a flowchart for referring the patient 201 to the healthcare provider 601 on the medical marketing website 502. The service provider provides 401 the medical marketing website 502. The service provider signs 402 the marketing agreement with the healthcare provider 601. The healthcare provider 601 is added 403 to the medical marketing website 502. The medical marketing website 502 obtains 404 marketing for the healthcare provider 601 through a marketing campaign. The medical marketing website 502 thereby attracts 405 patients. The medical marketing website 502 collects 406 information from the patient 201. The medical marketing website 502 transfers 407 the patient information to the healthcare provider 601, i.e., the selected healthcare provider 601. The healthcare provider 601 verifies 408 insurance benefits for a referred patient 201. The healthcare provider 601 may also verify if the health condition of the patient 201 may be treated or if it is possible to allot an appointment to the patient 201.

If the healthcare provider 601 does not accept 409 the patient 201, the patient information is transferred 407 to the next selected healthcare provider 601 prioritized by the patient 201. If the healthcare provider 601 accepts 409 the patient 201, the healthcare provider 601 signs 410 an agreement stating no charge of the co-payment for the patient 201 at the time of the referred medical service. The patient 201 may get notified 411 about the acceptance for the medical service by one of electronic messaging, web messaging, etc. The patient 201 then schedules 412 an appointment with the healthcare provider 601 and presents 413 the printed signed agreement to the healthcare provider 601 on the day of appointment. The healthcare provider 601 sends 414 the co-payment bill to the service provider.

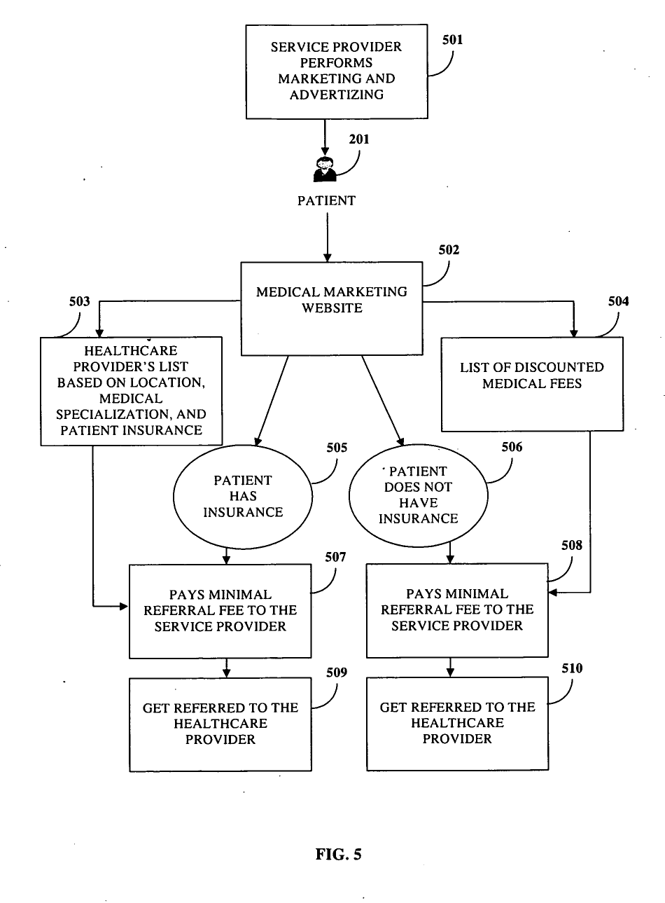

FIG. 5 exemplarily illustrates a flowchart for managing medical payments of insured patients and uninsured patients by a service provider. The service provider provides a medical marketing website 502 through which the marketing and advertising of the healthcare providers are performed 501. The patient 201 logs on to the medical marketing website 502 which displays a list 503 of the healthcare providers based on one or more of medical specialization, location, and patient insurance. The medical marketing website 502 also displays a list 504 of the discounted medical fees. The healthcare providers displayed in the medical marketing website 502, have signed the marketing agreement with the service provider and pay predefined subscription fees to the medical marketing website 502. The discounted medical fees of the healthcare providers based on medical specialization and practice size is predetermined. The healthcare providers may also have to update account fees and the documents needed for quality assurance. If the patient 201 has insurance 505, the insured patient pays 507 the minimal referral fee to the service provider and gets referred 509 to the healthcare provider 601. If the patient 201 does not have insurance 506, the uninsured patient pays 508 the minimal referral fee to the service provider and gets referred 510 to the healthcare provider 601 at the discounted medical fee.

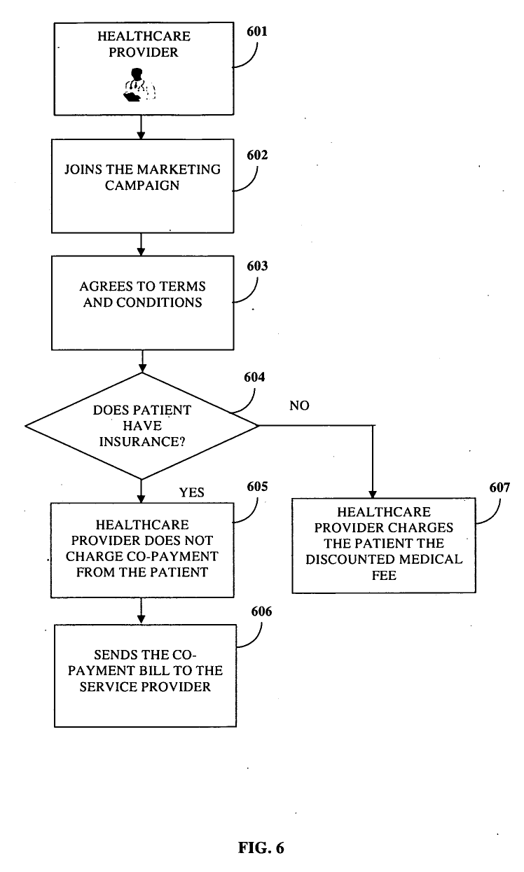

FIG. 6 exemplarily illustrates a flowchart of managing payments by the healthcare provider 601 on accepting to provide the medical service to an insured patient or an uninsured patient. The healthcare provider 601 joins 602 the marketing campaign on the medical marketing website 502. The healthcare provider 601 agrees 603 to terms and conditions put forth by the service provider of the medical marketing website 502. If the patient 201 has insurance 604, the healthcare provider 601 does not charge 605 the co-payment from the patient 201 and sends 606 the co-payment bill to the service provider. The healthcare provider 601, on receiving the transferred patient information, may verify the insurance benefit of the insured patient, possibility of treatment of health condition of the patient 201, and possibility to allot the appointment to the patient 201. The healthcare provider 601 has an option of accepting or rejecting to provide the medical service to the patient 201. If the patient 201 does not have insurance 604, the healthcare provider 601 charges 607 the patient 201 the discounted medical fee based on the contract signed with the service provider.

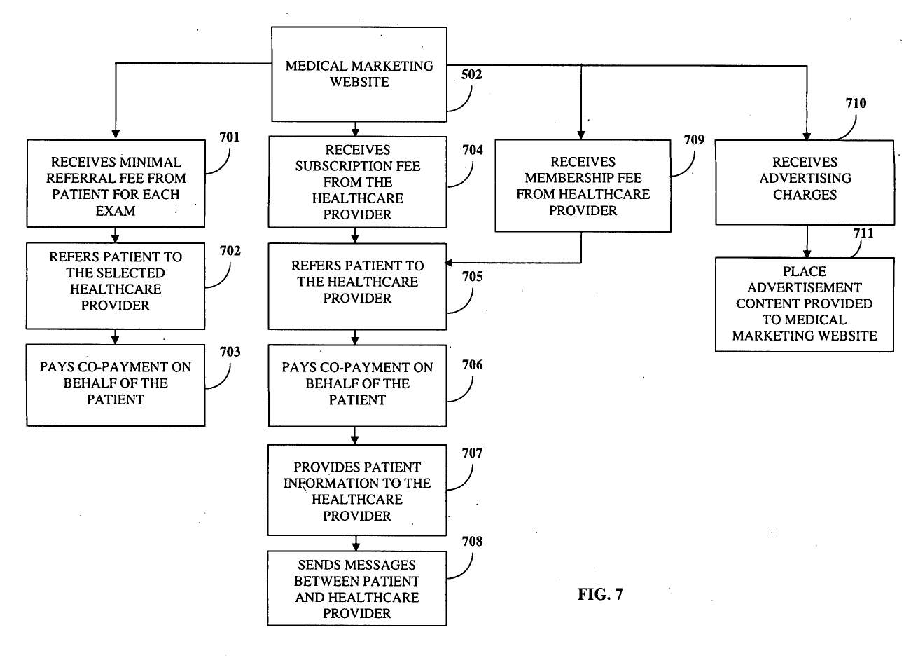

FIG. 7 exemplarily illustrates a flowchart of the services provided by the medical marketing website 502. The service provider provides the medical marketing website 502. The patient 201 may use the services provided on the medical marketing website 502. The medical marketing website 502 receives 701 the minimal referral fee from the patient 201 for each medical service required. The medical marketing website 502 refers 702 the patient 201 to the selected healthcare provider 601. The medical marketing website 502 then pays 703 the co-payment on behalf of the patient 201 to the healthcare provider 601. The medical marketing website 502 receives 704 the predefined subscription fees from the healthcare provider 601 for marketing the services of the healthcare provider 601 on the medical marketing website 502.

The medical marketing website 502 refers 705 the patient 201 to the healthcare provider 601 and pays 706 the co-payment to the healthcare provider 601. The medical marketing website 502 provides 707 the patient information to the healthcare provider 601 and then notifies the patient 201. The medical marketing website 502 may also send 708 messages between the patient 201 and the healthcare provider 601. The medical marketing website 502 receives 709 the membership fee from the healthcare provider 601 on signing the marketing agreement for the marketing campaign. The medical marketing website 502 then refers 705 the patient 201 to the healthcare provider 601. The medical marketing website 502 then adds the healthcare provider 601 to the medical marketing website 502. The medical marketing website 502 receives 710 the advertising charges from the healthcare provider 601. The medical marketing website 502 places 711 advertisement content provided to the medical marketing website 502 by the healthcare provider 601.

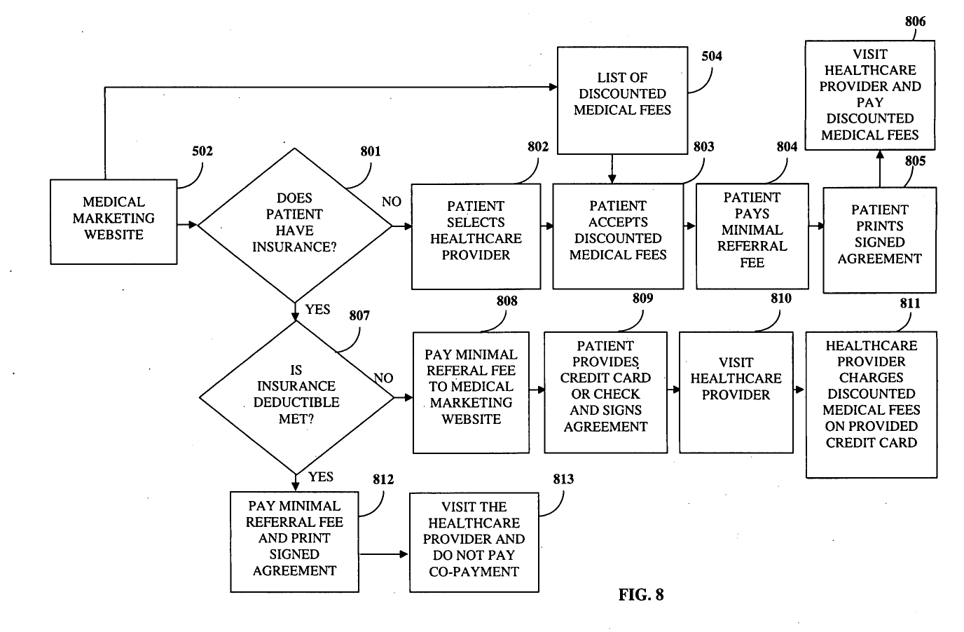

FIG. 8 exemplarily illustrates a flowchart for connecting the insured patient and the uninsured patient to the healthcare provider 601 through the medical marketing website 502. The medical marketing website 502 displays the list 504 of the discounted medical fees. If the patient 201 does not have insurance 801, the uninsured patient selects 802 the healthcare provider 601. The uninsured patient then accepts 803 the discounted medical fee displayed on the medical marketing website 502. The uninsured patient pays 804 the minimal referral fee. The uninsured patient prints 805 the signed agreement, signed by the selected healthcare provider 601. The uninsured patient then visits 806 the healthcare provider 601 and pays the discounted medical fees. If the patient 201 has insurance 801, the medical marketing website 502 checks if insurance deductible is met. The insurance deductible is the amount the insured patient must pay toward a claim before the insurance company begins to pay. For example, if the insured patient has a $500 claim and the policy has a $100 insurance deductible, the insured patient pays $100 and the insurance company will pay $400.

If the insurance deductible is not met 807, the insured patient pays 808 the minimal referral fee to the medical marketing website 502. When the medical marketing website 502 refers the insured patient to the healthcare provider 601, the healthcare provider 601 agrees to charge a percentage of the medical bill which is applied to the insurance deductible and the remaining part of the medical bill is sent to the service provider. Along with the patient information provided to the medical marketing website 502, the insured patient may provide 809 a method of payment, for example, a credit card or checking account to debit. The insured patient signs the agreement, visits 810 the healthcare provider 601, and allows the healthcare provider 601 to charge 811 the provided credit card for the discounted medical fee of the insurance deductible. This results in a percentage saving for the insurance deductible paid by the insured patient. If the insurance deductible is met 807, the insured patient pays 812 the minimal referral fee and prints the signed agreement. The insured patient then visits 813 the healthcare provider 601 and does not pay the co-payment. The selected healthcare provider 601 accepts the co-payment from the service provider instead of the patient 201 on signing the agreement on the medical marketing website 502.

The difference between the insurance deductible and the co-payment is that the insurance deductible is the initial dollar amount the insured patient must pay out of pocket before the insurance company pays the share. The insurance deductible is usually a flat dollar amount generally paid each calendar year. Usually, the higher the insurance deductible, the lower is the premium. The co-payment is the share or percentage of covered expenses the insured patient must pay in addition to the insurance deductible. The co-payment is usually paid for each visit to the healthcare provider 601. For example, the insurance company may pay 80% of covered charges after the insured patient pays the insurance deductible. The insured patient would then pay the remaining 20% as the co-payment until a maximum out of pocket expense is reached.

Consider for example, the patient 201 has a medical bill of $1000 and Blue Cross insurance. The patient 201 needs to have a magnetic resonance imaging (MRI) scan. The patient 201 goes to the medical marketing website 502 and indicates a need to be referred to a diagnostic center. The patient 201 specifies the health condition, location, and insurance cover. The list of the identified healthcare providers is displayed to the patient 201 on the medical marketing website 502 where the healthcare providers are categorized based on medical specialization, location, and patient insurance. The patient 201 may select one or more of the identified healthcare providers for a medical service and prioritizes the selected healthcare providers. The patient information is transferred to a selected healthcare provider 601 for acceptance to provide the medical service to the patient 201, where the selected healthcare provider 601 has the option to accept or reject providing the medical service to the patient 201 on the medical marketing website 502. If the healthcare provider 601 rejects to provide the medical service to the patient 201, the patient information is transferred to the next selected healthcare provider 601 prioritized by the patient 201 and if the healthcare provider 601 accepts to provide the medical service to the patient 201, the selected healthcare provider 601 signs an agreement. When the insurance deductible is met, the medical marketing website 502 asks the patient 201 to pay $50 to obtain the referral. If the patient 201 does not use the medical marketing website 502, then on $1000 medical bill, there may be a $200 co-payment. The co-payment of the patient 201 may be 20% of the medical bill. In this case, the patient 201 saves $150.

When the insurance deductible is not met, the patient 201 has the insurance deductible of $2000 which is not met. When the patient 201 indicates that the insurance deductible is not met, the patient 201 pays $100 to the medical marketing website 502 and a different agreement is submitted to the healthcare provider 601. The healthcare provider 601 agrees to charge the patient 201 for half of the medical service and the other half may be paid by the service provider. The patient 201 then pays the healthcare provider 601 $500 and the medical marketing website 502 $100 for the medical bill of $1000. The patient 201 thereby saves $400. If the patient 201 does not have insurance, the medical marketing website 502 signs a discounted medical fee agreement with the healthcare provider 601 for each medical service. The patient 201 may be given the list of the discounted medical fee. If the patient 201 agrees with the discounted medical fee, the patient 201 pays the medical marketing website 502 and is referred to the contracted healthcare provider 601. The patient 201 then pays the healthcare provider 601 $400 and the medical marketing website 502 $100 for the medical bill of $1000. The patient 201 thereby saves $500.

Consider another example, where the patient 201, for example, Mr. Jones, needs to go for a medical examination. Mr. Jones needs to see a healthcare provider 601 having medical specialization in internal medicine. Mr. Jones is insured with Blue Cross. Mr. Jones knows his co-payment is $25 and that he is also responsible for 20% of the final medical bill. Mr. Jones learns about the no co-payment system via the medical marketing website 502. Mr. Jones logs in to the medical marketing website 502, provides the patient information, and requests for a healthcare provider 601 having medical specialization in internal medicine. Mr. Jones pays $10 to the medical marketing website 502 and obtains, for example, three names and information of local healthcare providers. Mr. Jones prioritizes the healthcare providers based on personal preferences. A link to the website of the selected healthcare provider 601 may also be available. The medical marketing website 502 then refers Mr. Jones to the selected healthcare provider 601.

The healthcare provider 601 has, for example, 24 hours to verify eligibility of the patient 201. The healthcare provider 601 may accept or reject Mr. Jones. If the healthcare provider 601 accepts Mr. Jones, the healthcare provider 601 will sign an agreement on the medical marketing website 502 to collect the co-payment from the service provider rather than Mr. Jones. A message may be sent to Mr. Jones stating acceptance for the medical service, and the signed agreement may also be sent to Mr. Jones. Mr. Jones will contact the healthcare provider 601 for scheduling the appointment for the medical service and will provide the printed copy of the signed agreement to the healthcare provider 601 to prevent collection of the co-payment and billing during future visits. The healthcare provider 601 has received a patient 201 as a result of the marketing and advertisement efforts of the medical marketing website 502 and the patient 201 has saved the co-payment amount.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the information database 202c, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of managing medical payments in a medical marketing environment hosted by a service provider, comprising the steps of:
acquiring information of a patient;
identifying healthcare providers based on said acquired patient information, wherein information of said identified healthcare providers is provided to said patient;
selecting one or more of the identified healthcare providers by the patient for a medical service, wherein said selected healthcare providers are prioritized by the patient;
transferring the acquired patient information to a selected healthcare provider based on said prioritization by the patient for acceptance by said selected healthcare provider to provide said medical service to the patient;
signing an agreement for not accepting co-payment from the patient by the selected healthcare provider that accepts to provide the medical service to the patient; and
paying said co-payment to the selected healthcare provider by said service provider on behalf of the patient;
whereby said medical payments between the patient and the healthcare providers are managed in the medical marketing environment and the co-payment to be paid by the patient to the healthcare provider is waived in exchange for a minimal referral fee, thereby saving healthcare costs for the patient.

2. The method of claim 1, further comprising a step of scheduling an appointment between the patient and the selected healthcare provider for the medical service.

3. The method of claim 1, further comprising a step of registering the patient with one of an insured section and an uninsured section in the medical marketing environment, wherein the patient pays said minimal referral fee on said registration.

4. The method of claim 3, the healthcare providers in the medical marketing environment provide discounted medical fees to the patient on said registration to said uninsured section.

5. The method of claim 4, wherein an agreement is signed between the healthcare provider and the patient for said discounted medical fees and other discounts.

6. The method of claim 1, wherein the healthcare providers pay predefined subscription fees on registration in the medical marketing environment.

7. The method of claim 1, wherein the healthcare providers advertise services in the medical marketing environment, wherein the healthcare providers are charged for said advertising.

8. The method of claim 7, wherein a marketing invoice sent to the healthcare providers for the advertising offsets the co-payment.

9. The method of claim 1, further comprising a step of categorizing the healthcare providers based on one or more of medical specialization, location, and patient insurance.

10. The method of claim 1, wherein the selected healthcare provider has an option of one of said accepting and rejecting to provide the medical service to the patient.

11. The method of claim 10, wherein the acquired patient information is transferred to a next selected healthcare provider prioritized by the patient on said rejection by the selected healthcare provider.

12. The method of claim 1, wherein the patient information comprises one or more of personal information, insurance cover information, and health condition information.

13. The method of claim 1, wherein the selected healthcare provider accepts the co-payment from the service provider instead of the patient on signing said agreement in the medical marketing environment.

14. A system for managing medical payments in a medical marketing environment hosted by a service provider, comprising:
an information acquisition module for acquiring information of a patient;
an identification module for identifying healthcare providers based on said acquired patient information, wherein information of said identified healthcare providers is provided to said patient;
a selection module for enabling the patient to select one or more of the identified healthcare providers for a medical service, wherein said selected healthcare providers are prioritized by the patient;
an information transfer module for transferring the acquired patient information to a selected healthcare provider based on said prioritization by the patient for acceptance by said selected healthcare provider to provide said medical service to the patient;
an agreement module for enabling the selected healthcare provider that accepts to provide the medical service to the patient, to sign an agreement for not accepting co-payment from the patient; and
an accounting module for accounting said co-payment to be paid to the selected healthcare provider by said service provider on behalf of the patient.

15. The system of claim 14, further comprising a registration module for registering the patient and the healthcare providers in the medical marketing environment, wherein the patient pays a minimal referral fee on said registration, further wherein the healthcare providers pay predefined subscription fees on said registration.

16. The system of claim 14, further comprising an advertising module for advertising services of the healthcare providers in the medical marketing environment.

17. The system of claim 14, further comprising a categorization engine for categorizing the healthcare providers based on one or more of medical specialization, location, and patient insurance.

18. The system of claim 14, wherein said information transfer module transfers the acquired patient information to a next selected healthcare provider prioritized by the patient on rejection by the selected healthcare provider.

19. The system of claim 14, further comprising a scheduling engine for facilitating scheduling of an appointment between the patient and the selected healthcare provider for the medical service.

20. The system of claim 14, further comprising an information database for storing the acquired patient information and profile information of the healthcare providers.

21. A computer program product comprising computer executable instructions embodied in a computer-readable medium, wherein said computer program product comprises:
a first computer parsable program code for acquiring information of a patient in a medical marketing environment hosted by a service provider;
a second computer parsable program code for identifying healthcare providers based on said acquired patient information, wherein information of said identified healthcare providers is provided to said patient;
a third computer parsable program code for enabling the patient to select one or more of the identified healthcare providers for a medical service, wherein said selected healthcare providers are prioritized by the patient;
a fourth computer parsable program code for transferring the acquired patient information to a selected healthcare provider based on said prioritization by the patient for acceptance by said selected healthcare provider to provide said medical service to the patient;
a fifth computer parsable program code for enabling the selected healthcare provider that accepts to provide the medical service to the patient, to sign an agreement for not accepting co-payment from the patient; and
a sixth computer parsable program code for paying said co-payment to the selected healthcare provider by said service provider on behalf of the patient.
